(19) United States
(12) Patent Application Publication
(10) Pub. No.: US 2022/0115876 A1
(43) Pub. Date: Apr. 14, 2022

(54) SERIES-CONNECTED BATTERY CELL CHARGER WITH CELL BALANCING

(71) Applicant: Primex Wireless, Inc., Lake Geneva, WI (US)

(72) Inventor: JAMES F. WIEMEYER, Homer Glen, IL (US)

(21) Appl. No.: 17/069,692

(22) Filed: Oct. 13, 2020

(51) Int. Cl. H02J 7/00; H02J 7/35

(52) U.S. Cl. CPC H02J 7/0014; H02J 7/0047; H02J 7/35

(57) ABSTRACT

A battery charger is configured to independently charge a plurality of single cells in a battery of series connected single cells. In one example, the battery charger provides a plurality of independent charging current paths to the plurality of single cells via a plurality of removable charging connectors. Each charging connector is associated with a different charging stage and configured to connect to a single cell of a battery of single cells connected in series. A top charging stage and each of a plurality of middle charging stages are grounded by independent isolated grounds. A bottom charging stage is grounded by a main ground. The respective, independent grounds of the charging stages serve as the reference voltages for charging each of the single cells independently.

### FIELD

The present disclosure relates to a battery charger with cell balancing.

### BACKGROUND

Rechargeable batteries are used in numerous applications. An individual battery often includes numerous electrochemical cells (often referred to simply as “cells”) that are electrically connected in series with one another. During use a battery is discharged and a chemical reaction that releases electrons occurs. During charging, the chemical reactions in individual cells occur in reverse to store a charge.

### SUMMARY

When a battery is charged, it is possible that individual charge of each of the cells may vary. It has been found that batteries should be charged in a balanced manner to ensure battery longevity and utility. Some embodiments provide a battery charger that has a plurality of independently grounded charging stages. These charging stages connect to the individual cells of a battery to provide a balanced charge among or across the cells.

One embodiment provides a battery charger configured to independently charge a plurality of single cells in a battery of single cells connected in series. The battery charger provides a plurality of independent charging current paths to the plurality of single cells via one or more removable charging connectors. Each charging connector is associated with a different charging stage and configured to connect to a unique single cell of the battery. The charging stages include exactly one top charging stage, one or more middle charging stages, and exactly one bottom charging stage. The top charging stage and one or more middle charging stages are grounded by independent, dedicated isolated grounds. The bottom charging stage is grounded by a main ground that serves as a ground for the bulk of the electronic circuit. The respective, independent grounds of the charging stages serve as the reference voltages for charging each of the single cells independently.

Another embodiment provides a method of current delivery to a plurality of single cells in a battery of series connected cells. The method includes providing a plurality charging current paths to a plurality of cells via a plurality of charging stages. Each charging stage provides an independent path for charging current from an isolating current source to a single charging connector configured to connect to each single cell within a battery of single cells connected in series. Each of the charging stages is electrically isolated from each other and these dedicated isolated grounds act as independent voltage references for each of the charging stages.

Another embodiment provides a system including a battery charger that includes a plurality of charging stages and a battery of single cells connected in series. The plurality of charging stages includes at least a top stage and a bottom stage. Each stage except one stage is grounded by an isolated ground. The one stage that is not grounded by an isolated ground is grounded by path to a main ground. Within each charging stage, a charging connector provides an independent current path from a power source to a single cell of the battery. Each charging stage is configured to connect to exactly one single cell in the battery via exactly one charging connector. Thus, the charging stages can provide charging currents in a balanced manner so that each of the single cells of the battery can be independently charged to a comparable state of charge.

Other aspects and embodiments will become apparent by consideration of the detailed description and accompanying drawings.

### BRIEF DESCRIPTION OF THE DRAWINGS

FIG. 1 illustrates a pair of batteries with different series and parallel configurations of cell connections.

FIG. 2 illustrates a charging current in a battery.

FIG. 3 is a block diagram of a battery charge controller for charging a single energy storage cell in a plurality of single energy storage cells connected in series according to some embodiments.

FIG. 4 is a schematic diagram illustrating individualized current delivery to a plurality of single energy storage cells connected in series.

FIG. 5 is a schematic diagram illustrating the use of a single power source and a plurality of isolation transformers for current delivery to a plurality of single energy storage cells connected in series.

FIG. 6 is a schematic diagram illustrating the use of a single power source and a single isolation transformer for current delivery to a plurality of single energy storage cells connected in series.

### DETAILED DESCRIPTION

Before any embodiments are explained in detail, it is to be understood that the embodiments are not limited in their application to the details of construction and the arrangement of components set forth in the following description or illustrated in the following drawings. Embodiments are capable of other configurations and of being practiced or of being carried out in various ways. Also, it is to be understood that the phraseology and terminology used herein are for the purpose of description and should not be regarded as limiting. The use of “including,” “comprising,” or “having” and variations thereof are meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. As used within this document, the word “or” may mean inclusive or. As a non-limiting example, if it we stated in this document that “item Z may comprise element A or B,” this may be interpreted to disclose an item Z comprising only element A, an item Z comprising only element B, as well as an item Z comprising elements A and B.

A plurality of hardware and software-based devices, as well as a plurality of different structural components may be used to implement various embodiments. In addition, embodiments may include hardware, software, and electronic components or modules that, for purposes of discussion, may be illustrated and described as if most of the components were implemented solely in hardware. However, one of ordinary skill in the art, and based on a reading of this detailed description, would recognize that, in at least one embodiment, the electronic based aspects of the invention may be implemented in software (for example, stored on non-transitory computer-readable medium) executable by one or more processors. For example, “control units” and “controllers” described in the specification can include one or more electronic processors, one or more memory modules including non-transitory computer-readable medium, one or more input/output interfaces, one or more application specific integrated circuits (ASICs), and various connections (for example, a system bus) connecting the various components.

Rechargeable batteries often contain more than one single energy storage cell (“single cell”) connected in series, more than one single cell connected in parallel, or more than one series connected banks of parallel connected single cells. This arrangement scheme for single energy storage cells in a rechargeable battery can be written in a shorthand nomenclature that indicates the number of banks connected in series, and the number of parallel connected single cells included in a bank. For example, the shorthand notation 3S2P signifies three banks of cells connected in series, with two single cells connected in parallel per bank. As another example, the shorthand notation 3S1P signifies three banks of cells connected in series, with one single cell per bank.

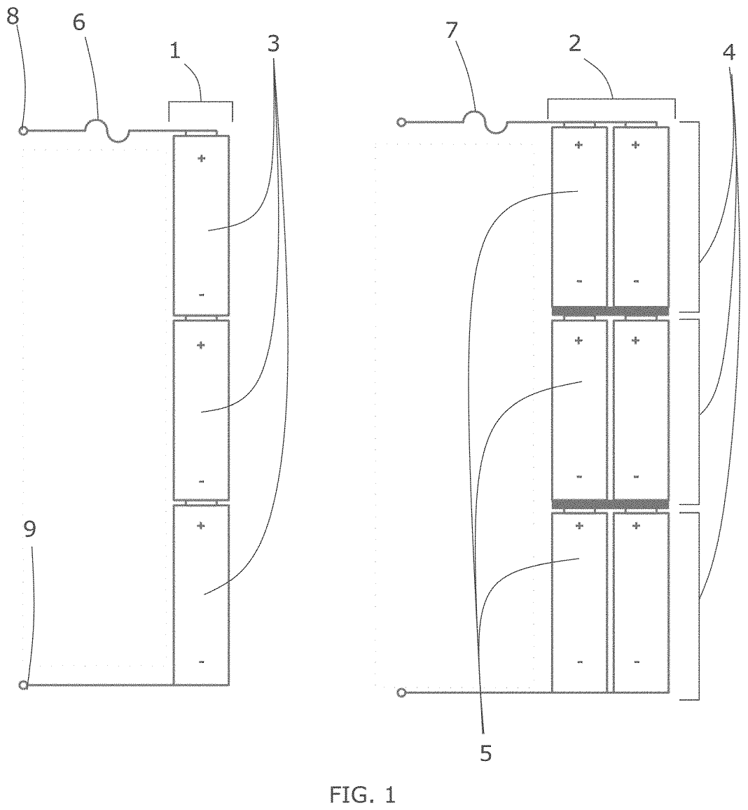

Referring now to FIG. 1 depicts a pair of batteries 1 and 2 with different configurations. Specifically, FIG. 1 depicts a 3S1P battery 1 including only series connected single cells 3 and a 3S2P battery 2 including series connected banks 4 of parallel connected single cells 5. Each of the batteries 1 and 2 contain protective measures, for example, fuses 6 and 7 to limit battery output current (not shown). Each battery 1 and 2 may also contain overvoltage protection electronics, undervoltage protection electronics, and battery temperature protection electronics (not shown). Battery chargers are often configured to charge a single cell battery (not shown), or larger series connected batteries 1 with multiple single cells 3 connected in series and with only one positive terminal 8 and only one negative terminal 9 available to a battery charger for energy storage.

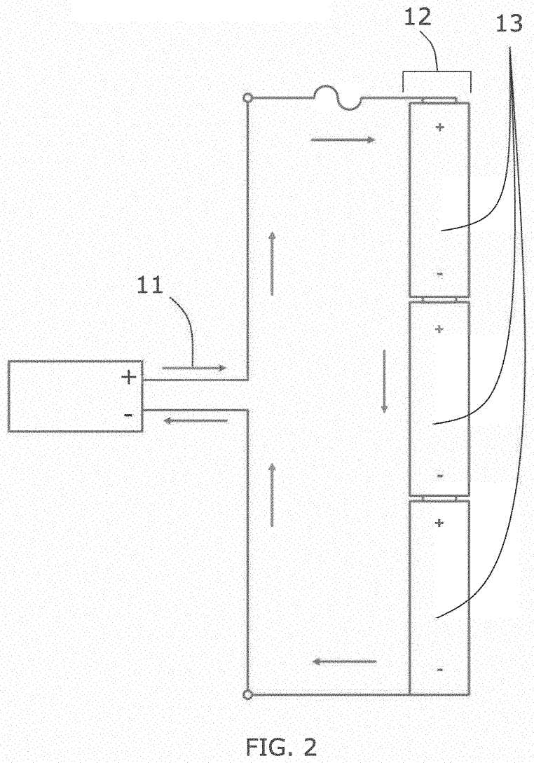

FIG. 2 illustrates charging current 11 in a battery 12. The single cells 13 are connected in series, and the same charging current 11 flows through each cell in the battery 12 during charging. A similar charging scheme applies with a 3S2P battery because each bank 4 in the battery 12 conducts the same amount of charging current 11.

The batteries 1, 2, and 12 shown in FIGS. 1 and 2 discharge externally through connected external devices. The single cells 3, 5, and 13 in the batteries 1, 2, and 12 also discharge internally at differing rates, depending upon the properties (for example, manufacturing variances, single cell temperature, single cell storage duration, and others) of the single cell 3, 5, and 13.

Over time and over charging cycles, a series connected single cell 3 or 13, or bank 4 of parallel connected single cells 5, with the highest internal discharge cumulatively becomes undercharged, while the remaining single cells 3, 5, and 13 cumulatively become overcharged. For example, each single cell 3, 5, and 13 may support a charged voltage of 4.2V. Therefore, a 351P battery would additively support a charged voltage=4.2V+4.2V+4.2V=12.6V.

A battery charger charging battery 1 or 12 via only two terminals 8 or 9, as described above, would use a charge cycle set at 12.6V. However, by using a charge cycle set at 12.6V, an individual undercharged single cell 3 or 13 or bank 4 experiences a termination of the charge cycle at a voltage lower than 4.2V while other single cells 3 or 13 or banks 4 experience charge cycle termination at a voltage higher than 4.2V. This undercharging and overcharging of single cells 3 or 13 or banks 4 with the result of different voltages for single cell 3 or 13 or bank 4 in the series connected array is called “cell imbalance.”

Datasheets and specifications for commercially-available batteries like batteries 1, 2 and 12 often lack defined internal discharge limits. As a result, the rate at which cell imbalance occurs cannot be predicted, and the reliability of the batteries 1, 2, and 12 decreases over time due to the imbalance. A method of charging the single cells 3, 5, and 13 of a battery in a balanced manner would increase the safety and reliability of series connected batteries 1 and 12.

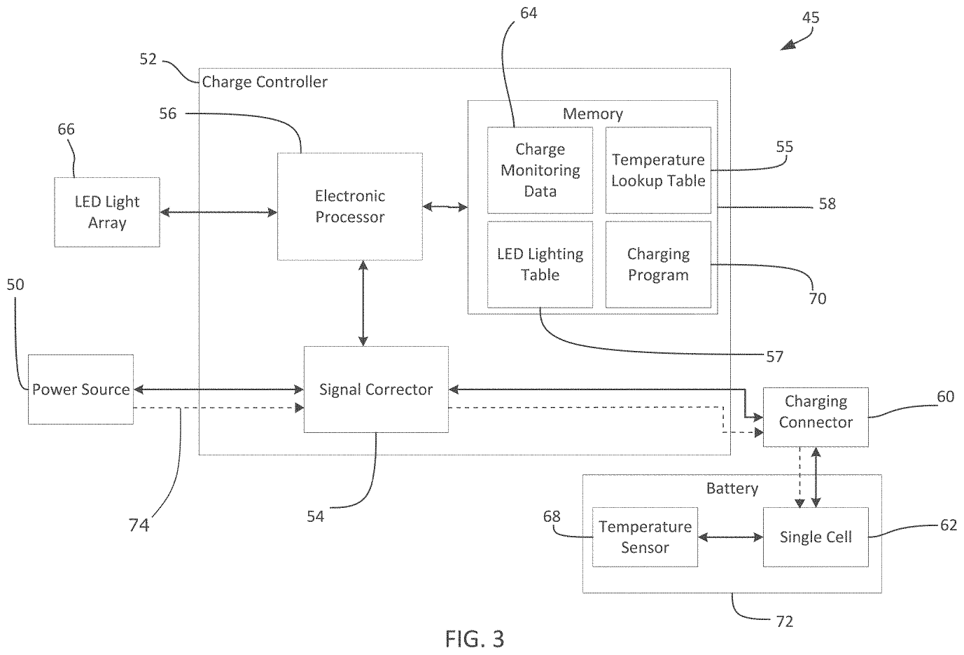

FIG. 3 is a block diagram of a system 45. In the example illustrated, the system 45 includes a power source 50, a charge controller 52, a charging connector 60, and a single energy storage cell (“single cell”) 62 of a battery 72. The power source 50 delivers electric power and provides a power signal to the charge controller 52 for the purpose of charging the single cell 62. The power source 50 may be, for example, an alternating current (AC) or direct current (DC) power source. In some embodiments, the power source is a renewable power source, for example, a photovoltaic cell, a piezo-electric generator, or other suitable source. In some embodiments, the power source 50 is a wall socket or other connection to an electric utility company power grid.

A current flow path 74 is provided from the power source 50 to the single cell 62 of a battery. The charge controller 52 and the charging connector 60 form part of the current path 74. The charging connector 60 provides a removable, electrically isolated connection to the terminals of the single cell 62. A fuse (for example, similar to the fuses 6 and 7), breaker, or switch (not shown) may be used in the charging connector 60 or battery 72 to protect the single cell 62 from levels of current that may damage the single cell 62.

The charge controller 52 may include a plurality of electrical and electronic components that provide power, operation control, and protection to other components and modules within the charge controller 52. In the example illustrated, the charge controller 52 includes, among other things, a power conditioner 54, an electronic processor 56 (for example, a programmable electronic microprocessor, microcontroller, distributed or local multi-processor, or similar device), and a memory 58 (for example, non-transitory, computer or machine readable memory).

In some embodiments, for example, depending on whether power source 50 is an AC power source or a DC power source, the power conditioner 54 includes a plurality of electrical and electronic components that rectify, regulate, or modulate the power signal to produce a desirable DC charging signal suitable for charging the single cell 62. The power conditioner 54 may include, among other things, a bridge rectifier for rectifying an AC signal, a pulse width modulator, and amplifier, a voltage regulator, signal noise reduction components, power factor correction circuitry, and other components to convert or transform an incoming power signal of an undesired type into a desirable DC signal. In the embodiment illustrated, the power conditioner 54 corrects the power signal that it receives from the power source 50 based on input from the electronic processor 56. The power conditioner 54 outputs a conditioned power to the charging connector 60 and communicates information about the conditioned power to the electronic processor 56.

The electronic processor 56 is communicatively connected to the memory 58, the power conditioner 54, and the charging connector 60. The electronic processor 56 is shown as physically integrated into the charge controller 52 but may also be positioned apart from or remotely from the charge controller 52, for example, as a physically remote, centralized master controller or cloud computing service. The charging connector 60 is communicatively connected to the single cell 62. The memory 58 may be volatile or non-volatile memory, or a combination thereof and may also be local accessible or remotely accessible over a network via a cloud storage service or data center. The electronic processor 56, in coordination with software stored in the memory 58 (for example, a charging program 70), the power conditioner 54, and the charging connector 60 may be configured to implement, among other things, the methods described herein. Functions described herein as being performed by the charge controller 52 should be understood to, at least in some embodiments, be performed by the charge controller 52 executing the charging program 70 via the electronic processor 56.

In a number of embodiments, a plurality of charge controllers 52 are communicatively connected to a master controller (not shown). In such embodiments, a single, centralized memory 58 in communication with the master controller acts as a centralized memory for every charge controller 52 connected to the master controller. Examples are described in further detail below.

In some embodiments, the charge controller 52 is configured to provide a charging current to the single cell 62 along the current path 74 through the charging connector 60. In one example, the charge controller 52 provides maximum power point tracking (MPPT), rectification, modulation, voltage regulation, and other power conditioning functions via the electronic processor 56 and power conditioner 54. The charge controller 52 monitors current flow, charging time, and temperature of the single cell 62 as it controls the charge of the single cell 62. Based upon the monitored charging values, the charge controller 52 adjusts the current flow and consequently the charging rate of the single cell 62.

The charge controller 52 may monitor the single cell 62 via a signal produced by the power conditioner 54 and listen with the electronic processor 56 for a response from the single cell 62 received at the power conditioner 54. This response can be used by the electronic processor 56 to produce charge monitoring data 64 pertaining to the single cell 62 (for example, state of charge data, state of health data, cell temperature data, etc.) The electronic processor 56 stores the charge monitoring data 64 in memory 58. The charge controller 52 may also use electronic processor 56 to keep track of charging time, charging current, charging voltage, etc. and store these items as charge monitoring data 64 in memory 58 as well.

In some embodiments, the memory 58 includes tables, lists, or other updatable items of pre-stored data loaded in memory 58 at the time of manufacturing. The prestored data may come from the specifications of the charge controller 52, or from known characteristics of the battery 72 to be charged. The electronic processor 56 correlates the pre-stored data to the charge monitoring data 64 during the charging of the single cell 62 for the purpose of providing a charge of the single cell 62 without diminishing the health or function of the single cell 62. The correlation may also be performed by the electronic processor 56 during the charging process in order to ensure the fastest charge that the charge controller 52 is capable of providing to the single cell 62 without damaging the single cell 62. For example, the electronic processor 56 may monitor the power conditioner 54 as it outputs a desirable charging current to the single cell 62 via the charging connector 60. Responses received at the power conditioner 54 during this process deliver information about a temperature of the single cell 62 while the single cell 62 is charging. The electronic processor 56 correlates the temperature of the single cell 62 to a temperature lookup table 55 stored in memory 58. In one example, if the correlation indicates that the single cell 62 has reached or is close to a temperature that is likely to damage the single cell 62, the electronic processor 56 controls the power conditioner 54 to adjust the charging current provided to the charging connector 60. If the correlation indicates that the charging temperature is likely to result in the degradation or failure of the single cell 62, the electronic processor controls the power conditioner 54 to stop outputting current to the charging connector 60. In the case of an occurrence of a pre-programmed charging condition communicable to a user by an illumination of LED light array 66, the electronic processor 56 first identifies the condition by monitoring the power conditioner 54 to produce charge monitoring data 64. The electronic processor 56 then checks an LED lighting table 57 in memory 58 for a proper lighting code to display on LED light array 66, to indicate to a user of the charge controller 52 that a hazardous or noteworthy condition, for example, battery under voltage, battery not present, charge complete, out of temperature range, etc. has arisen.

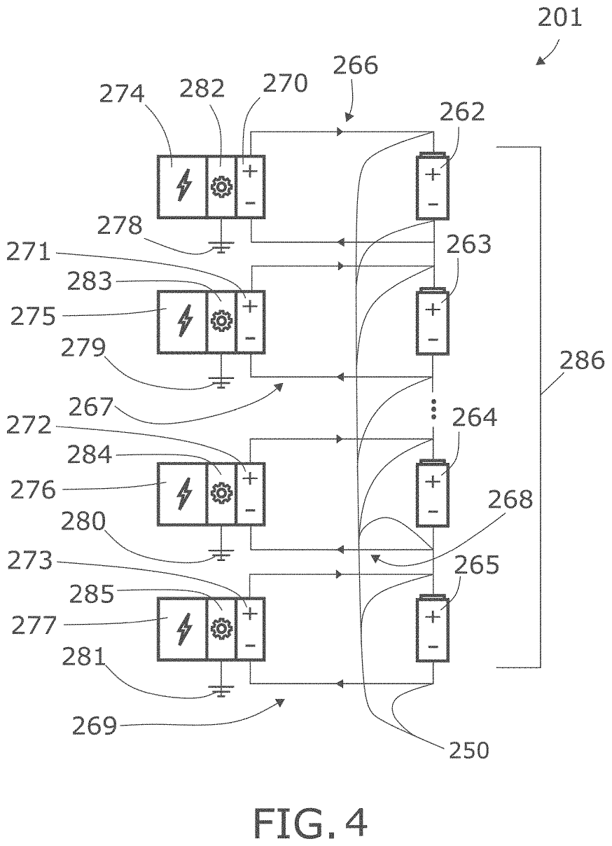

FIG. 4 depicts a schematic diagram illustrating a battery charger 201 and independent charging of a plurality of single cells 262, 263, 264, and 265 in a battery 286. The single cells 262, 263, 264, and 265 of the battery 286 are connected in series and are individually accessible for independent charging via terminal leads 250. As used in this example, “independent charging” means that dedicated charging current paths 266, 267, 268, and 269 are provided by charging connectors 270, 271, 272, and 273 from dedicated power sources 274, 275, 276, and 277 to dedicated isolated grounds 278, 279, 280, and 281 through each single cell 262, 263, 264, and 265 independently. For example, the dedicated charging current path 266 used for charging and provided to single cell 262 by charging connector 270 is independent from the other dedicated charging current paths 267, 268, and 269. In the embodiment shown, multiple charging connectors 270, 271, 272, and 273 provide multiple, mutually electrically isolated dedicated charging current paths 266, 267, 268, and 269 from dedicated power sources 274, 275, 276, and 277 through associated single cells 262, 263, 264, and 265 of a battery. Thus, the single cells 262, 263, 264, and 265 are collectively connected in series, charged independently, and configured to discharge in series when disconnected from the charging connectors 270, 271, 272, and 273.

The dedicated power sources 274, 275, 276, and 277 may include electrical isolation and current delivery elements, for example, isolation transformers or other components that provide an isolated source of current. Additionally, the dedicated power sources 274, 275, 276, and 277 may be themselves a power source that can be configured to inherently act as an electrical isolation and current delivery element, for example, a photovoltaic cell or a piezo-electric generator, as mentioned above.

Charge controllers 282, 283, 284, and 285 are connected to each of the power sources 274, 275, 276, and 277 and grounded by dedicated isolated grounds 278, 279, 280, and 281. A charging stage includes the combination of one dedicated power source 274, one charge controller 282, and one associated charging connector 270 configured to provide a dedicated charging current path 268 to a single cell 262 of a battery 286 and back to the charge controller 282. In some embodiments, the charge controllers 282, 283, 284, and 285 are linear charging systems, and in other embodiments the charge controllers 282, 283, 284, and 285 are switch-mode power supply charging systems. The dedicated isolated grounds 278, 279, 280, and 281 provide an independent reference voltage for each charge controller 282, 283, 284, and 285, and therefore provide an independent reference voltage for each single cell 262, 263, 264, and 265 as it charges independently of the others. In this way, control components included in the charge controllers 282, 283, 284, 285, and 285 receive more accurate feedback on the state of charge and voltage of each single cell 262, 263, 264, and 265 as it charges. Independent, dedicated isolated grounds 278, 279, 280, and 281 are achieved by electrically insulating each isolated ground 278, 279, 280, and 281 from one another. The isolated grounds 278, 279, 280, and 281 may be connected to a separate grounding component but may also provide high-impedance (for example, greater than 10 kΩ) paths to a shared grounding component, for example, a common ground or main ground, and at the same time be electrically insulated from one another. Such a high-impedance path to a shared grounding component can be provided by placing an electrical insulator in the path to the shared grounding component. For example, the path to the shared ground grounding component may include an air gap. Some embodiments include a main ground (not shown). In such embodiments, the main ground grounds the bottom charge controller 285 and provides a low-impedance (for example, tens of ohms) path to the shared grounding component. However, the main ground must still be electrically isolated from the dedicated isolated grounds 278, 279, 280, and 281. A low-impedance path to the shared grounding component can be provided by creating an electrically conductive path to the shared grounding component that does not include any electrical insulator. For example, the low-impedance path may be an electrically conductive path to a shared ground created with copper wire. The “main ground,” as used herein, is a ground that serves as a ground for the bulk of the electronic circuit (for example, the circuit including the entirety of the battery charger 201) and may include an earth ground.

As described above, the plurality of charging connectors 270, 271, 272, and 273 provide electrically isolated, independent, dedicated charging current paths 266, 267, 268, and 269 from a plurality of associated, dedicated power sources 274, 275, 276, and 277 to each single cell 262, 263, 264, and 265 in a battery 286 of single cells 262, 263, 264, and 265. This is done by providing individual, dedicated charging current paths 266, 267, 268, and 269 running from the dedicated power sources 274, 275, 276, and 277 to the charge controllers 282, 283, 284, and 285, from the charge controllers 282, 283, 284, and 285 to the charging connectors 270, 271, 272, and 273, from the charging connectors 270, 271, 272, and 273 to the single cells 262, 263, 264, 265, from the single cells 262, 263, 264, 265 back to the charging connectors 270, 271, 272, and 273, and from the charging connectors 270, 271, 272, and 273 back to the charge controllers 282, 283, 284, and 285. In some embodiments, at least one of the dedicated charging current paths 266, 267, 268, and 269 also includes a path from the charge controllers 282, 283, 284, and 285 back to the dedicated power sources 274, 275, 276, and 277. In some embodiments, the battery 286 includes exactly one top single cell 262, exactly one bottom single cell 265, and may include one or more middle single cells 263 and 264. In such embodiments, independent, dedicated charging current paths 266, 267, and 268 for the top single cell 262 and middle single cells 263 and 264 run from charge controllers 282, 283, and 284 through the top single cell 262 and middle single cells 263 and 264 and back to dedicated isolated grounds 278, 279, and 280 at the charge controllers 282, 283, and 284. In the same embodiments, the dedicated charging current path 269 for bottom single cell 265 runs from a charge controller 285 associated with the bottom single cell 265 through the bottom single cell 265 via the bottom charging connector 273 and back to a main ground (not shown) connected to the charge controller 285. Thus, in some embodiments, none of the dedicated charging current paths 266, 267, 268, and 269 provided by the charging connectors 270, 271, 272, and 273 for the single cells 262, 263, 264, and 265 share a common ground while charging.

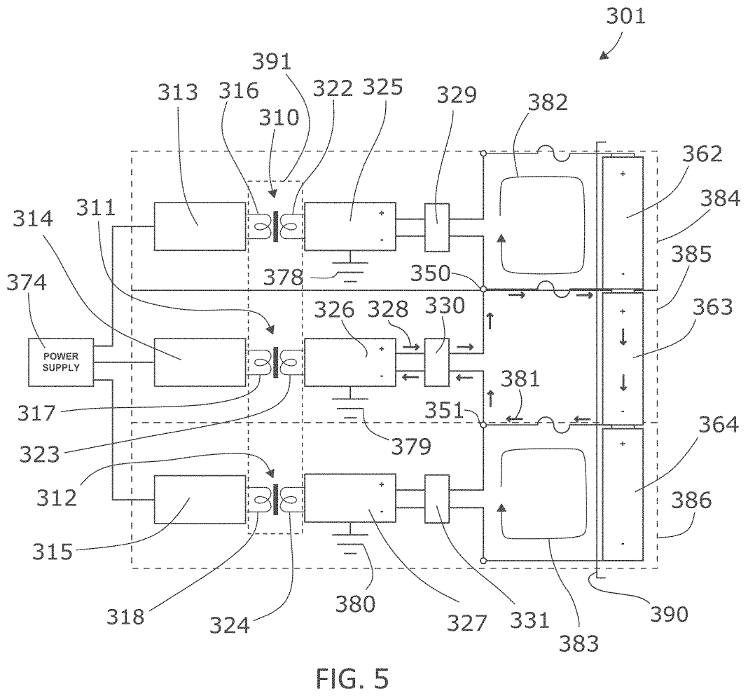

Referring now to FIG. 5, a battery charger 301 is connected to a single AC power source 374 and a plurality of electrical isolation and current deliver elements 391 in the form of isolation transformers 310, 311, and 312. The isolation transformers 310, 311, and 312 output current to a plurality of single cells 362, 363, and 364. The cells 362, 363, and 364 are connected in series. The AC power source 374 sends an AC signal to a plurality of transformer drivers 313, 314, and 315. The transformer drivers 313, 314, and 315 are connected to primary windings 316, 317, and 318 of a plurality of isolation transformers 310, 311, and 312. As the AC signal flows through the primary windings 316, 317, and 318 an oscillating electromagnetic field is generated. A current is induced in the secondary windings 322, 323, and 324 of the isolation transformers 310, 311, and 312 in the form of an isolated version of the oscillating AC signal. The isolated version of the AC signal flows from the secondary windings 322, 323, and 324 to charge controllers 325, 326, and 327. The isolated power is conditioned by a charge controller 52 to produce a desired DC charging current 328. The charge controllers 325, 326, and 327 monitor each single cell 362, 363, and 364 of a connected battery 390 through associated charging connectors 329, 330, and 331 to determine the state of charge and temperature of each of the single cells 362, 363, and 364. In some cases, the charge controllers 325, 326, and 327 also determine the health of the single cells 362, 363, and 364 by monitoring the single cells 362, 363, 364. The charge controllers 325, 326, and 327 may also adjust their respective current outputs based on the health or temperature of the single cells 362, 363, and 364. Dedicated isolated grounds 378 and 379 serve as independent reference voltages for any such determinations or controls for independent charging of a top single cell 362 and middle single cell 363 in the battery 390. A main ground 380 serves as the reference voltage for the charge controller 327 charging the bottom single cell 364. In the embodiment shown, the current 328 output by the charge controller 326 flows along a charging current path 381 to the single cell 363 and through the terminal leads 350, 351 of the single cell 363 of the battery 390 via charging connector 330.

In some embodiments, the charging current paths 381, 382, and 383 are not entirely independent of one another. In the embodiment shown, the charging current path 381 is not fully independent of charging current paths 382 and 383 used by charge controllers 325 and 327. In such embodiments, an orchestration of the charging stages 384, 385, and 386 allows each of the charging current paths 381, 382, and 383 to be effectively used independent of one another.

The charge controllers 325, 326, and 327 may be equipped with I/O interfaces and configured to communicate charge monitoring data 64 to one another wirelessly or by wire. The sharing of charge monitoring data 64 between charge controllers 325, 326, 327 helps to ensure a balanced charge of each single cell 362, 363, 364 and battery 390. In some embodiments, the charging stages 384, 385, 386 are configured to discharge the single cells 362, 363, 364. The discharge may be performed in a balanced manner by similar sharing of charge monitoring data 64 between the charge controllers 325, 326, 327 of each charging stage 384, 385, 386.

In some embodiments, the charge controllers 325, 326, and 327 are each configured to charge single cells 362, 363, and 364 respectively in a constant voltage mode until a predetermined termination charging current in each of the single cells 362, 363, and 364 is reached. In this way, the charge controllers 325, 326, and 327 do not need to communicate with one another while charging, and a full, balanced charge of each single cell 362, 363, and 364, of the battery thus occurs based upon the independently grounded voltage and current readings of the single cells 362, 363, and 364, by the charge controllers 325, 326, and 327. This is explained in further detail below.

In some of embodiments, the battery 390 includes temperature sensors 68 disposed on the exterior of the single cells 362, 363, and 364. The temperature sensors 68 may be thermistors or other analog devices that communicate analog signals to the electronic processor 56, or integrated devices that communicate digitally with the electronic processor 56. For example, the electronic processor 56 of each of the charge controllers 325, 326, and 327 correlates these analog or digital signals to the temperature lookup table 55 in memory 58 and in response the charge controllers 325, 326, 327 starts, stops, reduces, or increases the charging or discharge currents accordingly for each of the single cells 362, 363, and 364 based upon the temperature of the single cells 362, 363, and 364. In some cases, a master controller (not shown) is communicatively connected to each of the charge controller 325, 326, and 327. In such cases, the functions of the electronic processor 56 and memory 58 of each of the charge controllers may be performed by the master controller and a centralized master memory (not shown). The master controller and master memory may coordinate the operation of charge controllers 325, 326, and 327 such that a balanced charge of the battery 72 is achieved without damaging any of the single cells 362, 363, and 364.

In some embodiments a USB connection, DC connection, or PoE (power over Ethernet) connection may act as a power source 50 for the charge controller 52. In such cases, the power source 50 similarly provides power to a plurality of charging stages including isolated grounds 378, 379, and 380, and a power conditioner 54 conditions the power for charging the battery 72.

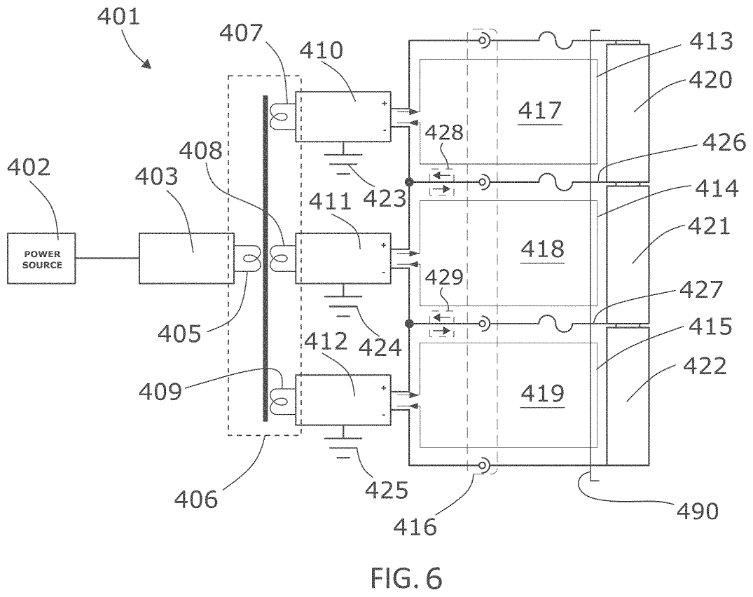

Referring now to FIG. 6, a battery charger 401 is connected to a single DC power source 402. Current flows from the single DC power source 402 to a single transformer driver 403. The single transformer driver 403 converts the current into an AC signal to excite a primary winding 405 of an isolation transformer 406. A current is induced in the secondary windings 407, 408, 409 of the isolation transformer 406 in the form of isolated versions of the oscillating AC signal. The isolated versions of the oscillating AC signal flows from the secondary windings 407, 408, and 409 to charge controllers 410, 411, and 412.

Charge controllers 410, 411, and 412 convert the oscillating AC signals to DC charging currents. Charging currents 413, 414, and 415 flow from the charge controllers 410, 411, and 412 via charging connector 416 along current paths 417, 418, and 419 to the single cells 420, 421, and 422. In embodiment shown, the charging connector 416 is a single connector piece including a plurality of electrical mating connectors in multiple positions within the single connector piece. In other embodiments charging connector 416 includes several pieces housing electrical mating connectors. Electrical safety devices 430, 431, and 432 are disposed on at least one lead of each current path 417, 418, and 419. In the example shown, the electrical safety devices 430, 431, and 432 are electrical fuses and prevent overcurrent from reaching the single cells 417, 418, and 419 during charging or during discharge of the battery 490 into short circuited loads during use. In other embodiments, the electrical safety devices 430, 431, and 432 are switches, or other devices that are configured to interrupt current flow.

Although the current paths 417, 418, and 419 are not independent, the charge controllers 410, 411, and 412 provide a balanced charge of the single cells 420, 421, and 422 via a charging scheme based on observed loop currents. For example, the charge controllers 410, 411, and 412 may be configured to maintain a constant voltage at the single cells 420, 421, and 422 by supplying controlled amounts of current to the current paths 417, 418, and 419. Charging currents 413, 414, and 415 flow in a cyclical fashion while charging the single cells 420, 421, and 422 and therefore oppose one another on shared leads 426 and 427. Because dedicated isolated grounds 423, 424, and 425 serve as independent reference voltages and for each current path 417, 418, and 419 difference currents 428 and 429 can be observed on shared leads 426 and 427 when such opposition occurs. Charge controllers 410, 411, and 412 are configured to control the current applied to current paths 417, 418, and 419 to maintain a prescribed current. As a result, charge controllers 410, 411, and 412 are able to properly perform the charge control functions described with respect to FIG. 5.

In some embodiments, the charge controllers 410, 411, and 412 independently charge the single cells 420, 421, and 422 based on loop currents along charging paths 417, 418, and 419 determined using isolated grounds 423, 424, and 425, respectively, as reference voltages. In this way, a constant current charging scheme, a constant voltage charging scheme, or a constant current constant voltage charging scheme can be carried out by the charge controllers 410, 411, and 412 with no need for intercommunication of the charge controllers 410, 411, 412.

In some embodiments, the methods and products disclosed herein are used to charge a battery 72, 286, 390, or 490 including banks 4 of parallel cells. The banks 4 include one or more single cells connected in parallel. In some cases, a bank includes exactly one single cell 62, 262, 263, 264, 265, 362, 363, 364, 420, 421, or 422. In other cases, a bank includes two or more single cells 62, 262, 263, 264, 265, 362, 363, 364, 420, 421, or 422, all connected in parallel. One or more of the banks 4 are associated with a dedicated charge controller 52, 282, 283, 284, 285, 325, 326, 327, 410, 411, or 412 and are grounded by isolated grounds 278, 279, 280, 378, 379, 380, 381, 423, 424, or 425. In such embodiments, the charge controllers 52, 282, 283, 284, 285, 325, 326, 327, 410, 411, or 412 provide independent charging currents or difference currents 428 or 429 to the banks 4. The banks 4 are thereby charged in a similar manner to that described with regard to single cells 62, 262, 263, 264, 265, 362, 363, 364, 420, 421, or 422.

Various embodiments, features, and advantages are set forth in the following claims.

What is claimed is:

1. A battery charger comprising:
a charging connector;
a power source;
a plurality of charging stages including a top stage, and a bottom stage, each stage, except a single stage having an isolated ground and being configured to connect to a bank of parallel connected single cells in a battery of series connected banks via the charging connector.

2. The battery charger of claim 1, wherein the single stage is directly connected to a main ground of the power source.

3. The battery charger of claim 1, wherein the single stage is connected to an isolated ground.

4. The battery charger of claim 1, wherein the charging connector is configured to connect to the bank and thereby provide a current path to the bank.

5. The battery charger of claim 4, wherein each charging stage further comprises an electrical isolation and current delivery element that electrically isolates the charging connector from the other stages.

6. The battery charger of claim 5 wherein the electrical isolation and current delivery element comprises an isolation transformer, and
wherein each isolated ground comprises a ground within a circuit energized by a secondary winding of the isolation transformer.

7. The battery charger of claim 5 wherein the electrical isolation and current delivery element comprises a photovoltaic cell.

8. The battery charger of claim 1, wherein each isolated ground is electrically isolated from other isolated grounds.

9. The battery charger of claim 1, wherein at least one of the plurality of charging stages further comprises a temperature sensor configured to sense a temperature of the bank.

10. A method of current delivery to a plurality of banks of parallel connected single cells in a battery of the banks connected in series via a battery charger comprising:
providing a plurality of current paths from a plurality of electrical isolation and current delivery elements to the plurality of banks in the battery via a charging connector connected to each of the banks and grounded by an isolated ground; and,
delivering current, from the plurality of electrical isolation and power delivery elements via the charging connector, to each of the banks.

11. The method of claim 10 wherein a bottom bank from the plurality of banks is directly connected to a common ground of the battery charger via the charging connector.

12. The method of claim 10 wherein the each of the electrical isolation and current delivery elements electrically isolates an associated charging stage from a plurality of charging stages.

13. The method of claim 10 wherein the plurality of electrical isolation and current delivery elements are a plurality of isolation transformers.

14. The method of claim 13 wherein the wherein each isolated ground is connected to a high-impedance path to a ground of a secondary winding of the isolation transformer.

15. The method of claim 10 wherein the plurality of isolation and current delivery elements are solar cells.

16. The method of claim 10, further comprising monitoring a temperature of each of the banks via an electronic processor in communication with temperature sensors disposed on an exterior of the banks.

17. A system comprising:
a battery charger having a plurality of charging stages including a top stage and a bottom stage, each stage except one stage having a charge controller grounded by an isolated ground; and,
a battery including a plurality of banks of parallel connected single cells, the banks connected in series,
wherein a plurality of charging connectors provide a current path from exactly one of the plurality of charging stages to exactly one of the banks such that each of the banks can be charged independently.

18. The system of claim 17, wherein the battery charger further comprises a plurality of electrical isolation and current delivery elements that electrically isolates the plurality of charging connectors from an earth ground.

19. The system of claim 17, wherein the battery charger further comprises an LED light array that illuminate in response to each of the banks of the battery being charged to the same voltage.

20. The system of claim 17, wherein the battery further comprises a plurality of temperature sensors disposed on an exterior of each bank in the plurality of banks.
